(19) United States
(12) Patent Application Publication
(10) Pub. No.: US 2008/0081256 A1
(43) Pub. Date: Apr. 3, 2008

(54) Electrodeposition of a Polymer Film as a Thin Film Polymer Electrolyte for 3D Lithium Ion Batteries

(76) Inventors: Marc J. Madou, Irvine, CA (US); Francesc Galobardes Jornet, Madrid (ES)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/837,286

(22) Filed: Aug. 10, 2007

Related U.S. Application Data
(60) Provisional application No. 60/837,357, filed on Aug. 10, 2006.

(51) Int. Cl. H01M 4/00; C25D 5/00; C25D 5/48; C25D 5/54; G03C 5/00

(52) U.S. Cl. 429/209; 205/159; 205/170; 205/229; 430/315

(57) ABSTRACT

Systems and methods for depositing a thin polymer layer on a 3D substrate, such as a carbon substrate or the like, by electrochemical means for use as an electrolyte in 3D lithium batteries. This layer stays adhered to the substrate surface by chemical bonding and provides electrical insulation and lithium ion conductivity after the film has been soaked in conventional liquid electrolyte solution containing lithium ions that acts as a plasticiser. In a preferred embodiment, the thin polymer layer is composed of poly(acrylonitrile) (PAN).

### CROSS-REFERENCE TO RELATED APPLICATIONS

This application claims the benefit of U.S. Provisional Application No. 60/837,357, filed Aug. 10, 2006, which is incorporated by reference.

### FIELD OF THE INVENTION

The present invention relates to polymer electrolytes for lithium ion batteries and, more particularly, to the electrodeposition of a thin polymer film on a 3D substrate as a thin film polymer electrolyte for 3D lithium ion batteries.

### BACKGROUND

Microbatteries based on 3D microstructures are shown to offer significant advantages in comparison to thin film devices for powering microelectromechanical systems and miniaturized electronic devices. Carbon-micro-electro-mechanical systems (C-MEMS) obtained from the pyrolysis of patterned photoresists are a powerful solution for the miniaturization of energy storage/conversion devices such as fuel-cells and microbatteries. The 3D shapes and the high aspect ratios of the resulting carbon structures are critical factors in applications where specific surface area plays a keyrole. Furthermore, lithographic techniques used in the C-MEMS technology may solve the downscaling problems of conventional carbon manufacturing techniques.

The application of C-MEMS as a lithium-ion battery anode has been demonstrated. However, the electrolyte and cathode are needed for the manufacturing of a complete 3D microbattery. Conventional lithium ion electrolytes are formed on one of the active electrodes or as a free-standing film/membrane by using coating manufacturing techniques mainly based on solvent casting strategies, resulting in planar films with thicknesses in the range of 10 to 200 μm. Although these films, specially the ones with high plasticizer content, show rubber-like behaviors, they are not conformable to the 3D structures of the C-MEMS anodes. Thus, the application of conventional lithium ion electrolyte technology in 3D microbatteries does not provide an optimal solution. Electrolyte materials and their deposition method for small 3D batteries have been classified as some of the most critical barriers for the development of small 3D batteries. Reports on micro and nano scale films that fulfill conformal electrolyte requirements are scarce in the literature.

Poly(acrylonitrile) polymer electrolytes have been reported and applied to lithium ion batteries using solvent casting and gelling techniques to fabricate lithium ion conductive membranes for planar batteries [see, e.g., K. M. Abraham et al., Ambient temperature rechargeable polymer-electrolyte batteries. J. Power Sources, 43-44 (1993) 195; W. Chun-Guey, et al., New Solid Polymer Electrolytes Based on PEO/PAN Hybrids. J. Appl. Polymer Sci., 99 (2005) 1530; H. Ryu et al., The Electrochemical Properties of Poly(acrylonitrile) Polymer Electrolyte for Li/S Battery. Mat. Sci. Forum, 510-511 (2006) 50]. Nevertheless, only electrodeposition methods result in a good approach for 3D batteries, as the electrolyte films need to be conformable and pinhole free at the same time.

Previous literature in conformable polymer electrolytes includes the deposition of poly(phenilene oxide) films on indium-titanium-oxide substrates [see, e.g., C. Rhodes et al., Nanoscale Polymer Electrolytes: Ultrathin Electrodeposited Poly(Phenilene Oxide) with Solid-State Ionic Conductivity. J. Phys. Chem. B, 108 (2004) 13079]. Poly(phenylene oxide) films have thicknesses around the 20 nm and breakdown when voltages up to 4V are applied, rendering them unusable for lithium ion batteries that charge up to the 4.2V. Also, reported ionic conductivities are in the low range (7E-10 S c−1) due to the high glass transition temperature of the material (210° C.).

Electrodeposited poly(acrylonitrile) films on common metallic substrates have variable thicknesses ranging from 42 to 80 nm depending on the monomer concentration [see, e.g., N. Baute et al., Electrodeposition of mixed adherent thin films of poly(ethylacrylate) and polyacrylonitrile onto nickel] and a lower glass transition temperature compared to poly(phenilene oxide), resulting in higher breakdown voltages and higher ionic conductivities. Although these thin polymers have been deposited onto common metallic substrates, deposition on carbon materials and further lithium ion half-cell or complete cell cycling has not been reported previously.

It is desirable to provide materials to be used as ultra thin polymer electrolytes for 3D lithium ion batteries having a thickness sufficient to hold higher voltages without breakdown and should have lower glass transition temperatures to increase polymer chain motion resulting in enhanced ionic conductivity.

### SUMMARY

Improved systems and methods are provided in which a thin polymer layer is deposited on a 3D substrate, such as a carbon substrate or the like, by electrochemical means for use as an electrolyte in 3D lithium batteries. This layer stays adhered to the substrate surface by chemical bonding and provides electrical insulation and lithium ion conductivity after the film has been soaked in conventional liquid electrolyte solution containing lithium ions that acts as a plasticiser. In a preferred embodiment, the thin polymer layer is composed of poly(acrylonitrile) (PAN).

### BRIEF DESCRIPTION OF FIGURES

The figures provided herein are not necessarily drawn to scale, with some components and features being exaggerated for clarity. Each of the figures diagrammatically illustrates aspects of the invention. Variation of the invention from the embodiments pictured is contemplated.

FIG. 1 is a work flow diagram of a C-MEMS process for forming high aspect ratio 3D structures.

FIGS. 2(a)-2(d) are SEM images of high aspect ratio 3D SU-8 posts [(a) and (b)] and carbon microelectrode arrays [(c) and (d)] formed using the process shown in FIG. 1.

FIG. 3(a) is a graph illustrating the galvanostic charge/discharge cycle behavior of patterned carbon arrays.

FIG. 3(b) is a graph illustrating the cyclic voltammetry of patterned carbon arrays between 0 and 2.0 V vs Li/Li and at a scan rate of 10 mV/s.

FIGS. 4(a) and 4(b) are schematics of non-conformable and conformable, respectively, electrolytes and their configuration in a 3D battery.

FIG. 5 is a schematic of an electrodeposition cell.

FIG. 6 is a graph showing a characteristic curve profile for acrylonitrile electrodeposition on carbon substrate.

FIG. 7 is a graph showing a chronoamperometry (constant potential) curve at potentials in the range of peak I showing carbon surface passivation.

FIG. 8 is a graph showing a chronoamperometry (constant potential) curve at potentials in the range of peak II showing film growth.

### DESCRIPTION

Improved systems and methods are provided in which a thin polymer layer is deposited on a 3D substrate, such as a carbon substrate or the like, by electrochemical means for use as an electrolyte in 3D lithium ion microbatteries. This layer stays adhered to the substrate surface by chemical bonding and provides electrical insulation and lithium ion conductivity after the film has been soaked in conventional liquid electrolyte solution containing lithium ions that acts as a plasticiser.

A microbattery is simply a battery providing power in the microwatt range. Power requirements may be intermittent over short or long periods or continuous, and in some cases there may be the need to accommodate high power pulses superimposed on a low microwatt background power drain. Batteries may be single cycle, low rate primary cells or multi-cycle secondary cells capable of being recharged many times. The range of power requirements is illustrated by the variety of relatively new miniature portable electronic devices such as cardiac pacemakers, hearing aids, smart cards, personal gas monitors, microelectromechanical systems (MEMS), embedded monitors, and remote sensors with RF capability.

Microbatteries based on 3D microstructures have been shown to offer significant advantages in comparison to 2D thin film devices for powering microelectromechanical systems and miniaturized electronic devices. A first simple observation is that with an array of 3D microelectrodes, a molecule might have to diffuse over a 10 μm distance only, which will be 1 million times faster than diffusing over a 1 cm distance. Thus, 3D configurations offer a means of keeping the diffusion distances “short” and provide enough active material such that 3D batteries will be capable of powering MEMS devices and microelectronic circuits for extended periods of time.

However, mobile electronic applications are becoming more power demanding as their features and level of integration increase. Lithium-ion batteries are the latest technology in power storage for such applications in the mid-scale range (e.g. Notebooks, portable video-audio players, photography, etc.). Nevertheless, small applications such as peacemakers, hearing aids, RF-ID tags and others lack of reliable small power sources. Dead volume in small batteries due to packaging and electrolyte materials causes a drop in the specific and volumetric capacities of the cells. Therefore, the application of rechargeable batteries in small applications has not yet been successful.

Ultra thin polymer films that show lithium ion conductivity are suitable for use in lithium ion batteries that need to minimize electrolyte dead volume and diffusion distance. The application of such ultra thin films can boost the performance of actual small scale lithium-ion batteries without the need of replacing electrode active materials, overcoming the actual limitations in the downscaling of conventional technologies.

Lithium ion batteries are composed of an anode, a cathode and a separator/electrolyte in between. The separator/electrolyte layer has two main objectives: Effective electronic insulation of the anode-cathode assembly to avoid short circuit of the battery, and high ionic conductivity of lithium cations to allow their movement between the two electrodes.

In U.S. application Ser. No. 11/057,389, entitled High Aspect Ratio C-MEMS Architecture, filed Feb. 11, 2005, which is incorporated by reference, a process comprising the pyrolysis of patterned photoresists (CMEMS) was demonstrated to constitute a powerful approach to building 3D carbon microelectrode arrays for use as an anode in 3D microbattery applications. High aspect ratio carbon posts (20:1) are achieved by pyrolyzing SU-8 negative photoresist in a simple one step process.

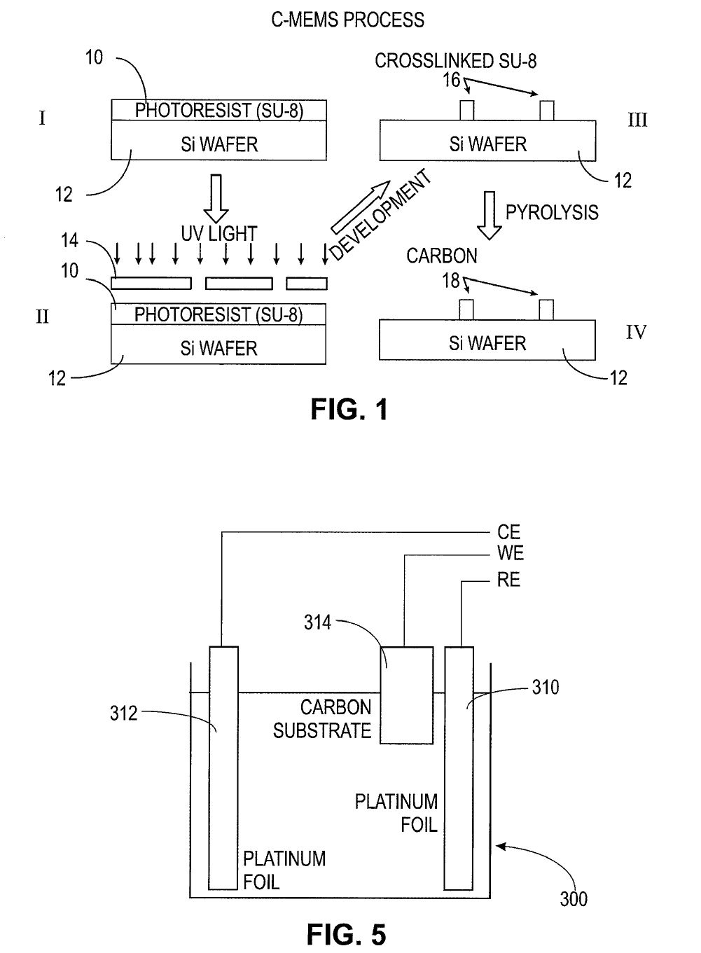

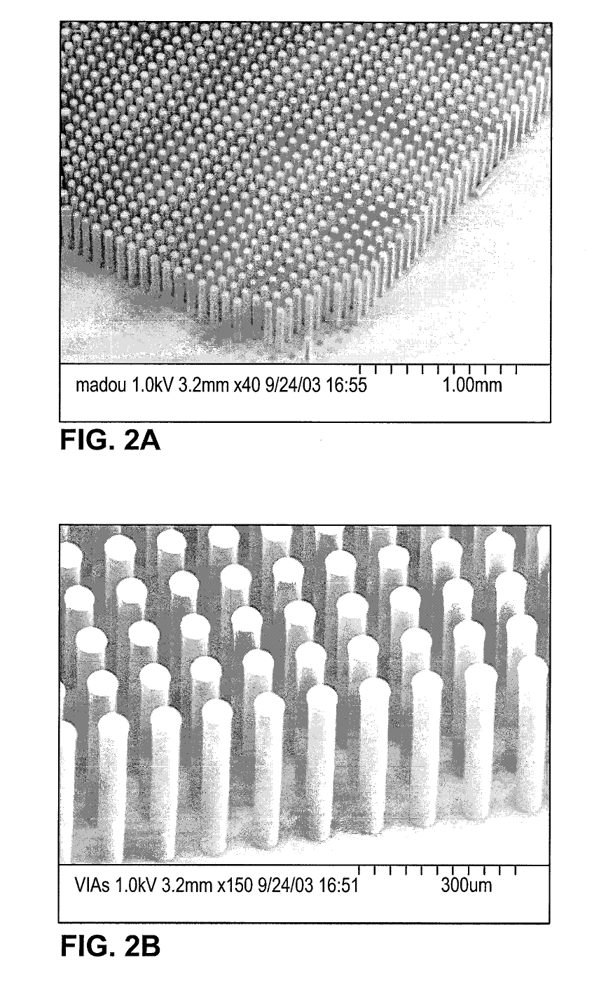

FIG. 1 illustrates the basic steps in the C-MEMS process in which carbon devices are made by treating a pre-patterned organic structure to high temperatures in an inert or reducing environment. More particularly, 3D high-aspect-ratio carbon structures can be made from patterned thick SU-8 negative photoresist. SU-8 negative photoresist is a high transparency UV photoresist that enables creation of “LIGA-type” structures using traditional UV photolithography. As depicted in FIG. 1, a layer of photoresist 10 is deposited on a Si wafer 12 by conventional means at step I. At step II, the photoresist 10 is exposed to UV light through a mask 14. The photoresist 10 is then developed to crosslink the UV light exposed material and the excess non-exposed photoresist 10 is removed leaving crosslinked SU-8 posts 16 at step III (see FIGS. 2(a) and 2(b)). Next, at step IV, the posts 16 are carbonized through a pyrolysis process. The geometry is largely preserved during the carbonization process although some isometric shrinkage occurs between the SU posts 16 and the formation of the carbon posts 18 (see FIGS. 2(c) and 2(d)).

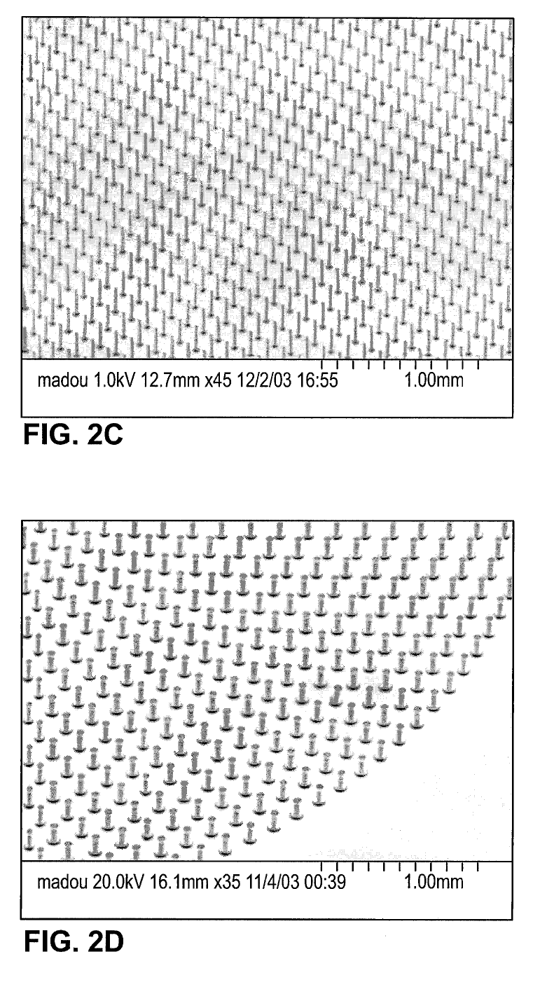

As shown in FIGS. 3(a) and 3(b), the pyrolyzed SU-8 material obtained after the C-MEMS process (FIGS. 2(c) and 2(d)) exhibits reversible intercalation/de-intercalation of lithium as demonstrated by the electrochemical galvanostatic and voltammetric experiments carried out on the carbon material. In non-patterned carbon films, the electrochemical behavior is similar to that of coke electrodes. The voltammetric sweep is analogous to those reported in the literature for other anode carbonaceous materials, with some evidence of electrolyte decomposition at high potentials and most of the Li+ intercalation/deintercalation occurring at lower potentials near the 0 V vs. Li/Li+. The galvanostatic measurements of the unpatterned film show a large irreversible capacity on the first discharge followed by good subsequent cycling behavior, which is also consistent with the behavior of other lithium ion battery negative electrodes. Metrics for the material are best summarized by considering the surface area normalized capacity, which was determined to be 0.070 mAhcot cm−2 for the second and subsequent cycles. For a fully dense carbon film, this corresponds to 220 mAh·g−1, which is within the range of reversible capacities reported for other types of carbons.

As expected, the patterned carbon electrodes shown in FIGS. 2 (c) and (d) exhibit the same qualitative electrochemical behavior as unpatterned electrodes. The voltammograms are virtually identical to those of the unpatterned carbon film electrode. Thus, there is no question that the C-MEMS electrode array is electrochemically reversible for lithium charging and discharging and that the characteristics of the pyrolyzed SU-8 array are similar to those of other reported carbon materials. The galvanostatic measurements for patterned C-MEMS electrodes were found to give a surface area normalized discharge capacity of 0.125 mA·cm−2 for the second and subsequent cycles. The C-MEMS electrode array delivers nearly 80% higher capacity than that of the unpatterned carbon film for the same defined working electrode area. The reason for the greater capacity arises from the additional specific active area of the posts.

More recently there have been numerous advancements on the C-MEMS 3D anode technology in order to reduce the internal resistance and increase the lithium intercalation reversible capacity through the modification and addition of various microfabrication processes. These advancements are discussed in detail in U.S. application Ser. No. 11/090,918, entitled Surface and Composition Enhancements to High Aspect Ratio C-MEMS, filed Mar. 25, 2005, which is incorporated by reference.

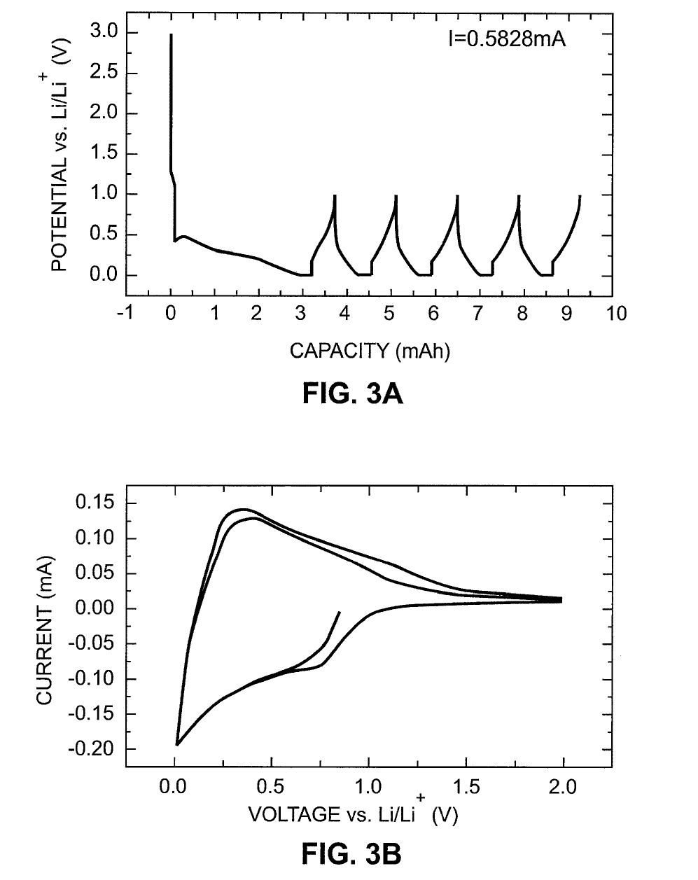

Most conventional lithium ion electrolytes, either solid or gel types, are formed on one of the active electrodes or as a free-standing film/membrane by using coating manufacturing techniques mainly based on solvent casting strategies, resulting in planar films with thicknesses in the range of 10 to 200 μm. Although these films, specially the ones with high plasticizer content, show rubber-like behaviors, they are not conformable to the 3D structures of the C-MEMS anodes such as those shown in FIGS. 2(c) and 2(d) for example. As shown in FIG. 4(a), which depicts a 3D electrode configuration 100 using a conventional lithium-ion electrolyte film, the application of conventional lithium-ion electrolyte technology in 3D microbatteries does not provide an optimal solution. The 3D configuration 100 includes an anode 110 comprising an array of high aspect ratio electrodes, an polymer electrolyte 112, a cathode 114 and current collectors 116. As depicted, the volume available for active materials and therefore the volumetric capacity of the battery is reduced. Moreover, the thickness of the polymer block 112 would be in the order of several hundreds of micrometers to completely cover the high aspect ratio carbon structures 110, increasing the internal resistance of the battery due to the limited ionic conductivity of any electrolyte 112 available.

The reduction of dead volume (non-active material space) in a 3D configuration can be accomplished through specific deposition methods capable of delivering thin films conformable to the 3-D electrode structures. A physical disposition similar to the one shown in FIG. 4(b), where the electrolyte thin film 212 covers the anode 210 and provides space for the cathode 214 while electrically insulating the anode-cathode assembly in the 3D configuration 200, not only overcomes the limitations in volumetric capacity and internal resistance but also reduces the lithium ion diffusion length allowing shorter charge times and higher discharge current densities. As depicted in FIG. 4(b), the cathode material preferably interlaces or surrounds the entire height of the electrode posts of the anode 210 while being separated therefrom by the thin film electrolyte 212.

Preferably, a 3D microbattery electrolyte would have the following characteristics:
Conformable to the anode 3D structures.
Nano/micro scale thick films.
Pinhole-free to ensure a correct insulation of the anode-cathode assembly.
High ionic conductivity to minimize internal resistance.
High dielectric breakdown constant up to 4.2 V for the given film thickness.
Chemical stability toward high oxidation voltages.
High electrical d.c. resistance to reduce self-discharge.
Solid or gel polymer electrolyte to avoid liquid leakage.

For the development of batteries with complex 3D anodes and cathodes, conventional deposition methodologies such as solvent casting or gelling are not suitable as they do not deliver conformable films. Electrochemical deposition from solution is the best candidate for material deposition in these conditions, but the materials that meet the specifications are limited. Furthermore, thin films are preferred because the internal resistance of the electrolyte can be minimized, enhancing the performance of the battery, especially at high current demands. Electrochemical deposition of polymers is a self-limiting process that results in pinhole-free nano/micro-meter thick films.

The electrodeposition of an insulating, self-limiting film on a 3D substrate, such as a carbon substrate, by means of electrochemistry is a preferred method for forming the thin film polymer electrolyte. Lithium ions can move through this layer once they are introduced into the system by immersing the film in conventional lithium-ion liquid electrolytes. At the same time, electrons are blocked by the electrically insulating nature of the film.

Materials to be used as ultra thin polymer electrolytes for 3D lithium ion batteries should be thick enough to hold higher voltages without breakdown and should have lower glass transition temperatures to increase polymer chain motion resulting in enhanced ionic conductivity.

Only a few materials have been reported as tested to be used as thin, conformal, pinhole-free electrolytes. One of the tested materials is poly(phenylene oxide) (PPO). However, coatings on carbon and further cycling have not been reported. Furthermore, the breakdown constant for the resulting films is not enough to withstand the 4.2V experienced by conventional lithium ion batteries, mainly due to the limited thickness of the films. Another disadvantage for PPO is the high glass transition temperature of the polymeric compound (210° C.), which induces a very low ionic conductivity due to the almost inexistent polymer chain motion at room temperature.

One example of a polymer electrolyte that possess the preferred characteristics, and can be used as a separator/electrolyte, as poly(acrylonitrile) (PAN). Other examples may include poly(ethyl acrylate) (PEA), a mixture of PEA and PAN, and the like. (See N. Baute et al., Electrodeposition of mixed adherent thin films of poly(ethyl acrylate) and polyacrylonitrile onto nickel, ePolymers, 63:1-20, 2004). The polymeric matrix is able to provide the mechanical strength needed to physically separate the cathode and the anode, thus electrically insulating them, and the liquid trapped within the matrix provides ionic conductivity for the movement of lithium cations.

The kinetics of the PAN deposition on carbon substrates is much faster (around 20 times) than the one for the PPO for both cyclic voltammogram or chronoamperometry deposition strategies.

In experiments with PAN, film thicknesses ranged from 20 nm to a few microns, i.e., 3 microns, on photoresist derived carbons electrodes, withstanding higher voltages without breakdown and reducing the self-discharge of the battery. The glass transition temperature of the PAN material is lower (85° C.) than equivalent PPO materials (PPO) and higher ionic conductivities can be expected, allowing higher current densities to be drawn from the cell.

For exemplary purposes only, the preferred process of electrodepositing a polymer film electrolyte/separator is described below with regard to PAN. One of skill in the art would readily recognize that the process can be modified to work with other polymers such as those noted above.

The preferred electrochemical means by which a thin PAN layer is deposited on a 3D substrate such as carbon, includes an electrodeposition bath that is an acetonitrile solution of acrylonitrile in concentrations ranging from 0.1 to 5M and a salt (tetrabutylammonium perchlorate—TBAP or tetramethylammonium perchlorate—TEAP) with a concentration of 5E-02M. The entire process is conducted in an oxygen free (<0.1 ppm O2) atmosphere.

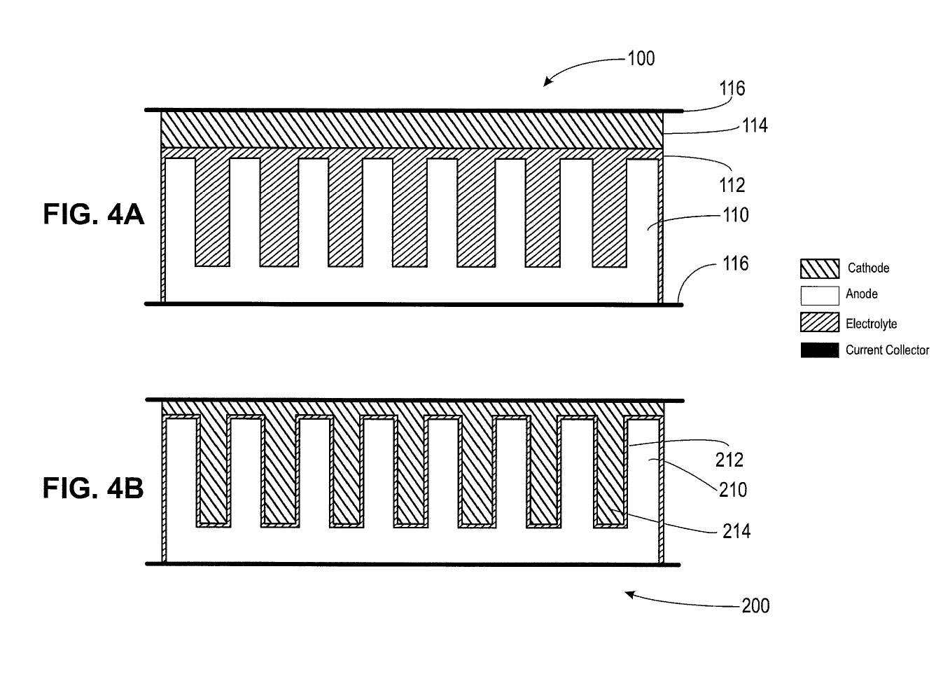

The solution is introduced into a three electrode cell 300 shown in FIG. 5. One platinum foil is used as a quasi-reference electrode 310 and a second one as a counter electrode 312. The substrate 314, carbon in this instance, is used as a working electrode (photoresist derived pyrolyzed carbon on SiO2/Si was used as substrate). The monomer solution is prepared by mixing Acrylonitrile (AN, 2.5 M) and Tetrabutylammonium Perchlorate (TBAP, 5E-02 M) in Acetonitrile (ACN). The two platinum electrodes 310 and 312 are inserted in the solution and contacted with alligator clips. The carbon substrate 314 is also dipped into the solution and electrically contacted. All the electrodes are connected to a potentiostat/galvanostat.

The potential of the working electrode 314 is swept from 0 mV to −2.8V versus the reference electrode 310 and the current passing through the cell 300 is measured. Two peaks are observed, corresponding to two different deposition mechanisms of the polymer. The thickness and quality of the polymer film can be adjusted by combining electrodeposition on both peaks. The first peak results in ultra-thin poly(acrylonitrile) films and the second yields a much thicker and rougher deposit. Combinations of cyclic voltammetry and chronoamperometry experiments used for the peak detection and film extension respectively are used to fine tune the thickness and properties of the films. Thicknesses in the range of about 15 nm to a few microns have been demonstrated. The morphology of the films is also highly dependent on the potential at which the working electrode is established.

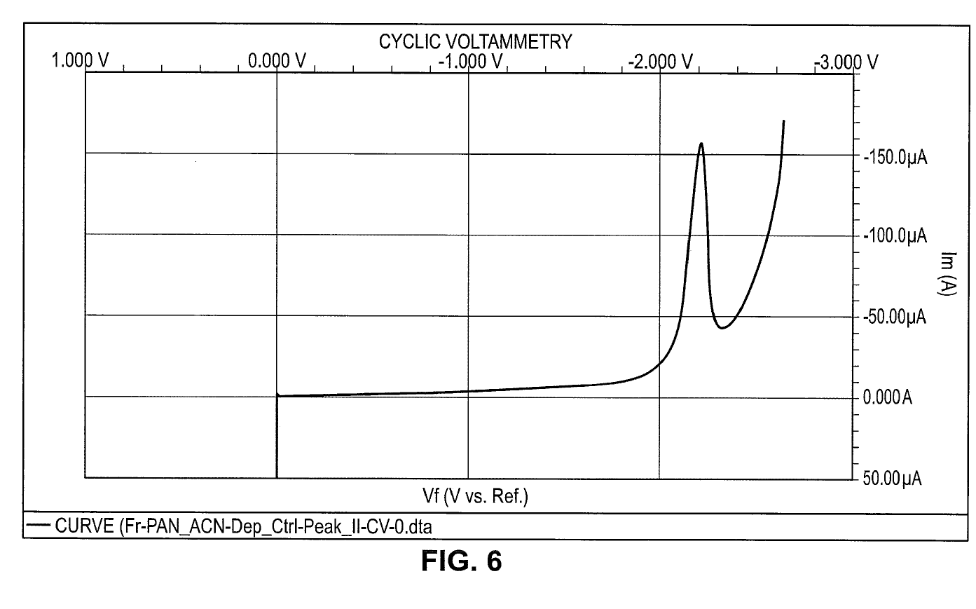

Referring to FIGS. 6-8, first, a cyclic voltammetry in the negative potential range is applied to the working electrode and a characteristic profile as depicted in FIG. 6 results as the acrylonitrile is electropolymerized onto the carbon surface. A well defined peak and shoulder reflect the two deposition mechanisms that can be used to optimize the thickness and morphology of the film. At the peak a grafting mechanism is provided that leads to very thin PAN films. At the shoulder the PAN chains deposited during the first potential scan are extended towards the solution increasing the thickness of the deposited film.

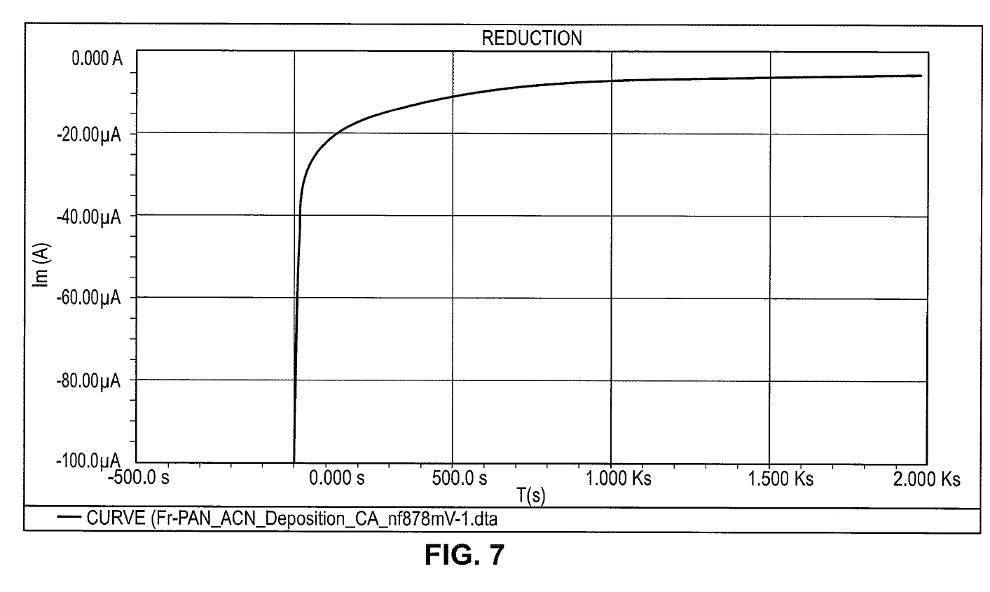

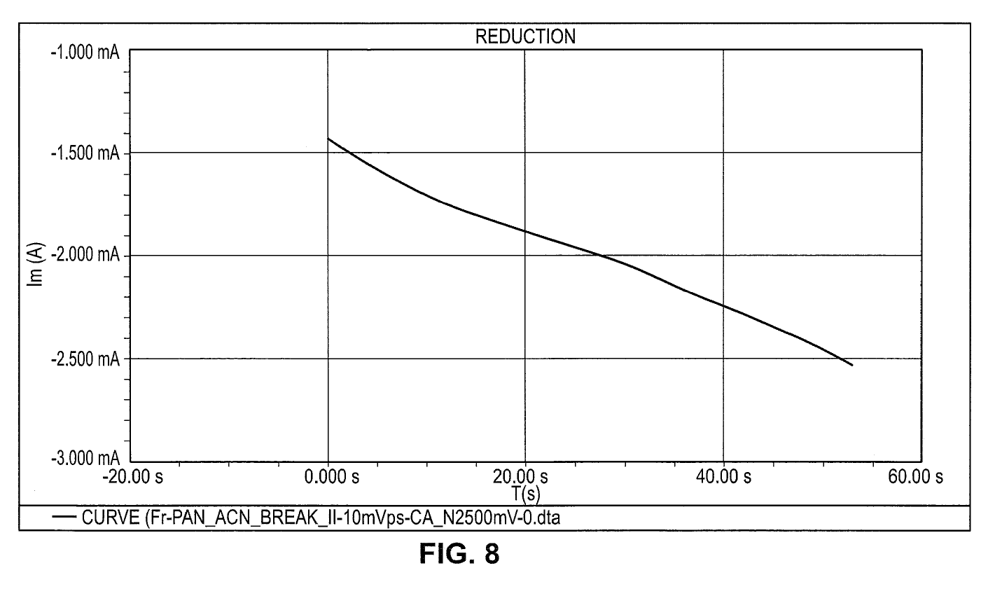

To effectively cover the carbon surface and thicken the PAN film, a constant potential is applied. If the potential is close to the first deposition peak, the magnitude of the current decreases showing the passivating nature of the film (see FIG. 7). On the other hand, if the potential is held at more negative potentials close to the shoulder, the intensity increases due to the growth of the film by chain extension (see FIG. 8).

After the deposition process the samples are rinsed with acetonitrile to remove traces of monomer and salt components. Further processing (e.g. drying, cleaning, annealing) can be used to condition the film. Lithium cations and plasticizers can then be introduced into the PAN matrix by soaking the substrate and polymer deposit into liquid electrolyte (EC:DMC 1:1/1M LiClO4 or equivalent) for a certain period of time to induce the ionic conductivity to the film to be used in lithium-ion batteries.

The soaking of the film in conventional lithuim-ion battery electrolytes used here as plasticisers (e.g. PC, EC, DMC, EMC or equivalent solvents combined with lithium salts) give rise to the ionic conductivity of the film. Various soaking times are needed depending on the thickness of the film and on the composition of the soaking solution.

PAN thin films in the range of the 25 nm deposited on photoresist derived carbon have been tested in a whole lithium-ion cell (LiMn2O4, carbon black and PVdF as a cathode material on aluminum foil). The PAN electrodeposited films proved to withstand a voltage of 4.0V before breakdown. Further testing with thicker and more porous films will be performed to optimize the ionic conductivity and the breakdown voltage as well as the electronic resistance.

The last step of the assembly of the complete 3D microbattery is the cathode coating. A cathode electrode slurry can be deposited on top of the polymer layer using conventional techniques so that the lithium ion battery is completed.

The design of the positive electrode or cathode needs to consider various aspects like the material set and application methodology, as well as the electrochemical response of the active material during the charge and discharge cycles. Different approaches have been suggested in the literature but common manufacturing techniques cannot be directly applied to 3D batteries as they are based on film casting and dry application. A dry application scheme would be catastrophic for the carbon anode structures as the pressures needed to obtain a uniform conformal coating would push the carbon structures beyond their mechanical strength or would damage the polymer electrolyte. Therefore, the application of a liquid-like slurry and post-coating drying step is preferable.

One cathode slurry used to coat the 3D structures described herein is standard a standard cathode slurry for lithium-ion batteries and includes an active material, a highly conductive phase to permit the flow of electrons through the electrode and a binder to hold the structure together. The chosen active material is LiMn₂O₄ powder with an average particle size of 3 μm. The conductivity enhancing material is Carbon Black of high conductive grade available from Degussa under the name CB Printex XE-2. Finally the binding material is a PVDF homopolymer available from Solvay Membranes division under the name Solef 1015.

All the materials come in powder form and need to be mixed into a paste which can be readily applied as a coating to the existing structures. As a vehicle for the slurry to be transferred, N-Methyl-2-Pyrrolidone (NMP), a solvent for PVDF, is used. The composition of the paste is 85% of active material (LiMn2O4), 10% of conductive powder (CB Printex XE-2) and finally a 5% of binder (PVdF). As the mixed paste will be pushed to reach the substrate bottom layer and the applied forces cannot exceed a specific value, the viscosity of the paste must be adjusted through the addition or evaporation of solvent (NMP) in the final mixture.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of the appended claims.

What is claimed:

1. A method of forming a thin film polymer electrolyte for lithium ion batteries comprising the steps of
electrochemically depositing polymer on an electrode substrate having three dimensional components forming a thin film of polymer on the substrate, and
soaking the polymer film in a lithuim-ion battery electrolyte solution.

2. The method of claim 1 wherein the polymer is poly(acrylonitrile) (PAN).

3. The method of claim 1 wherein the polymer is poly(ethyl acrylate) (PEA).

4. The method of claim 1 wherein the polymer is a mixture of PEA and PAN.

5. The method of claim 1 wherein the polymer film has thickness in a range from about 20 nm to about 3 microns.

6. The method of claim 1 wherein the electrode substrate is formed of carbon.

7. A method of forming a three dimensional lithium ion micro-battery comprising the steps of
forming a first electrode comprising a substrate have three dimensional components,
electrochemically depositing polymer on the first electrode substrate forming a thin film of polymer on the substrate,
soaking the polymer film in a lithuim-ion battery electrolyte solution, and
depositing a second electrode comprising a material surrounding the three dimensional components of the first electrode and separated from the first electrode by the polymer film.

8. The method of claim 71 wherein the polymer is poly(acrylonitrile) (PAN).

9. The method of claim 7 wherein the polymer is poly(ethyl acrylate) (PEA).

10. The method of claim 7 wherein the polymer is a mixture of PEA and PAN.

11. The method of claim 7 wherein the polymer film has a thickness in a range from about 20 nm to about 3 microns.

12. The method of claim 7 wherein the first electrode comprises a carbon substrate.

13. The method of claim 12 wherein the step of forming the first electrode includes the step of lithographically patterning a layer of photoresist and pyrolysizing the patterned photoresist converting it to the patterned photoresist to carbon.

14. The method of claim 13 wherein the carbon substrate includes high aspect ratio three dimensional components.

15. A lithium ion battery comprising
a first electrode comprising a 3D substrate structure, and
a thin film of polymer deposited on the substrate structured.

16. The lithium ion battery of claim 15 wherein the 3D substrate structure is formed of carbon.

17. The lithium ion battery of claim 15 wherein the polymer film is poly(acrylonitrile) (PAN).

18. The lithium ion battery of claim 15 wherein the polymer film is poly(ethyl acrylate) (PEA).

19. The lithium ion battery of claim 15 wherein the polymer film is a mixture of PEA and PAN.

20. The lithium ion battery of claim 15 wherein the polymer film has thickness in a range of about 20 nm to about 3 microns.

21. The lithium ion battery of claim 15 further comprising a second electrode formed about the three dimensional structure of the first electrode and separated from the first electrode by the polymer film.
